(19) United States
(12) Patent Application Publication
(10) Pub. No.: US 2003/0038126 A1
(43) Pub. Date: Feb. 27, 2003

(54) Ceramic wood-burning device

(76) Inventor: James P. Wheatman, Chesterton, IN (US)

Correspondence Address: HARTMAN & HARTMAN, P.C., 552 EAST 700 NORTH, VALPARAISO, IN, 46383, US

(21) Appl. No.: 10/064,841

(22) Filed: Aug. 22, 2002

Related U.S. Application Data
(60) Provisional application No. 60/314,445, filed on Aug. 23, 2001.

(51) Int. Cl. H05B 3/42

(52) U.S. Cl. 219/229

(57) ABSTRACT

A method and device for burning a pattern in a surface of wood or other charrable material. The device generally comprises a ceramic body having a raised pattern defined on a surface thereof and means for locally heating the raised pattern to a temperature sufficient to burn a pattern in a surface of wood contacted by the ceramic body. While various heating means are possible, two noted heating means are an electrically-resistive wire or an electrical-conductive ceramic material embedded in the ceramic body in proximity to the raised pattern, both of which serve to locally heat the raised pattern when current from a suitable electric current source flows therethrough.

### CROSS REFERENCE TO RELATED APPLICATIONS

This application claims the benefit of U.S. Provisional Application No. 60/314,445, filed Aug. 23, 2001.

### BACKGROUND OF INVENTION 1. Field of the Invention

The present invention generally relates to tools for creating decorative designs and patterns on surfaces. 2. Description of the Related Art

Tools and equipment currently available for creating decorative designs and patterns on wood and other charrable materials include metal hand tools and laser generators that produce a burned (i.e., charred or singed) pattern in a near-surface region of the material. Hand tools are labor-intensive, especially if a large surface is to be treated. For large surfaces or when a continuous or repetitive pattern is to be accurately reproduced, a laser is generally required. However, laser equipment is not readily affordable and often impractical for the general public. In addition, laser equipment cannot be easily transported, limiting use of the equipment to a studio or other permanent location.

### SUMMARY OF INVENTION

The present invention provides a method and device for burning a pattern in a surface of wood or other charrable material. The device generally comprises a ceramic body having a raised pattern defined on a surface thereof and means for locally heating the raised pattern, preferably to a temperature higher than portions of the ceramic body away from the raised pattern. The heating means is such that the raised portion is sufficiently heated to burn a pattern in a surface of wood contacted by the ceramic body. While various heating means are possible, two notable heating means are electrically-resistive wire or an electrical-conductive ceramic material embedded in the ceramic body in proximity to the raised pattern. Both of these heating means serve to locally heat the raised pattern when current from a suitable electric current source flows therethrough.

With the device described above, a method of burning a pattern in a surface of wood generally comprises passing an electrical current through the ceramic body to heat the raised pattern to a temperature sufficient to burn wood, and then contacting the surface of the wood with the ceramic body to burn the pattern in the surface of the wood. Because the heating means is in proximity to the raised portion, the temperature of the raised pattern is higher than portions of the ceramic body away from the raised pattern, such that the pattern defined by the raised pattern is accurately transferred to the wood surface.

In view of the above, it can be seen that a significant advantage of this invention is that patterns can be accurately reproduced, including continuous and repetitive patterns, in a wood surface (or surface of another charrable material) without the use of a laser. The device of this invention is more affordable and transportable than laser equipment, enabling the device to be widely used by the general public. As a result, the device and method of this invention can be practiced as a hobby, craft or business by a very large segment of the population to enhance the decorative appearance and value of a wide variety of goods.

Other objects and advantages of this invention will be better appreciated from the following detailed description.

### BRIEF DESCRIPTION OF DRAWINGS

FIGS. 1 through 9 show ceramic wood-burning tools in accordance with various embodiments of this invention.

### DETAILED DESCRIPTION

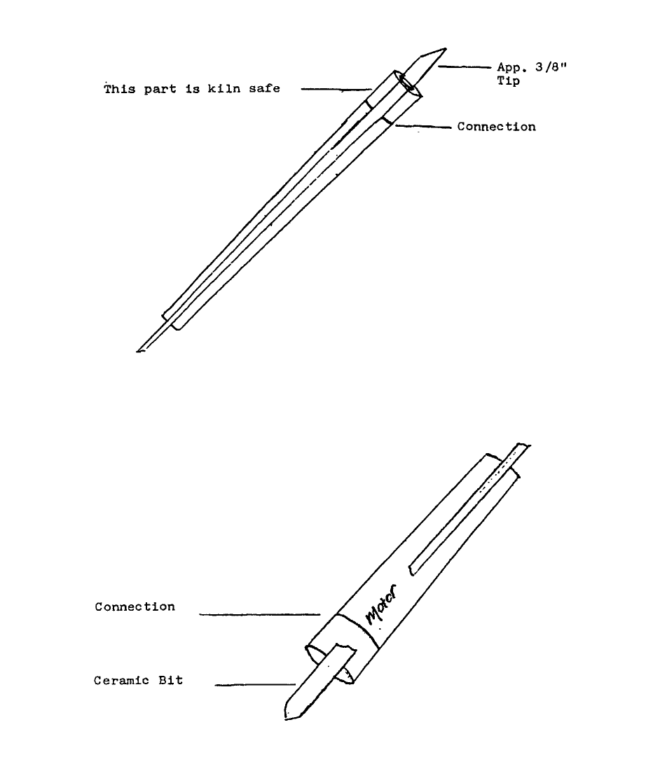

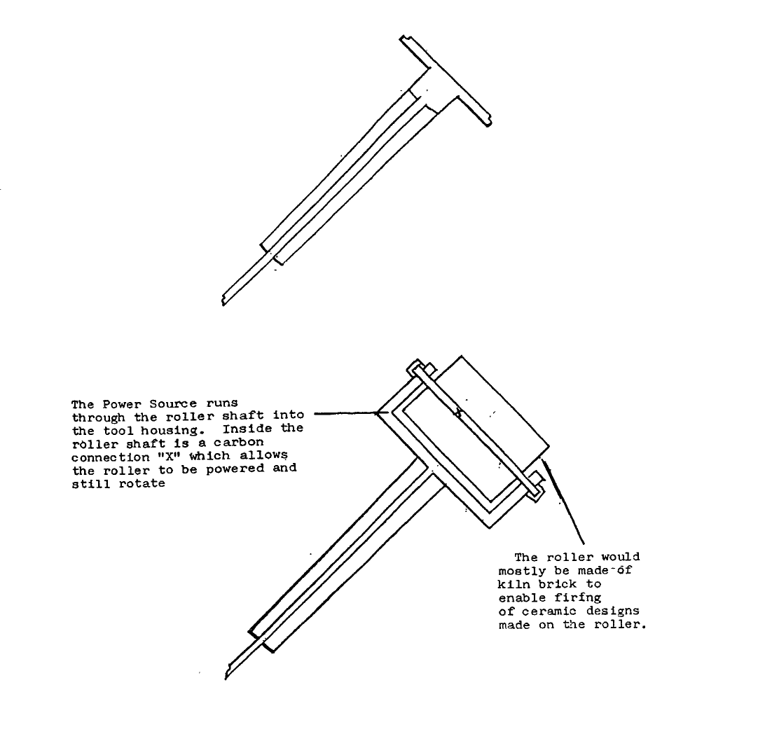

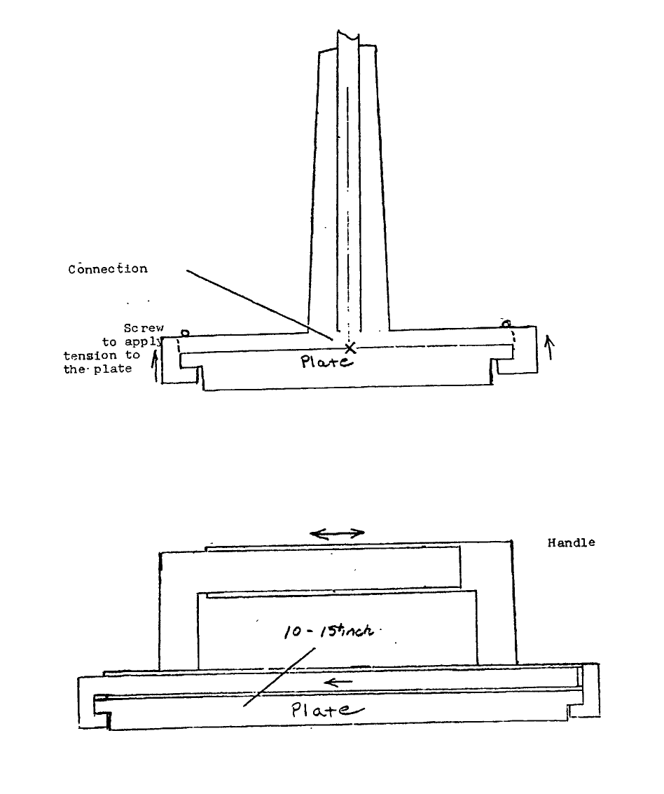

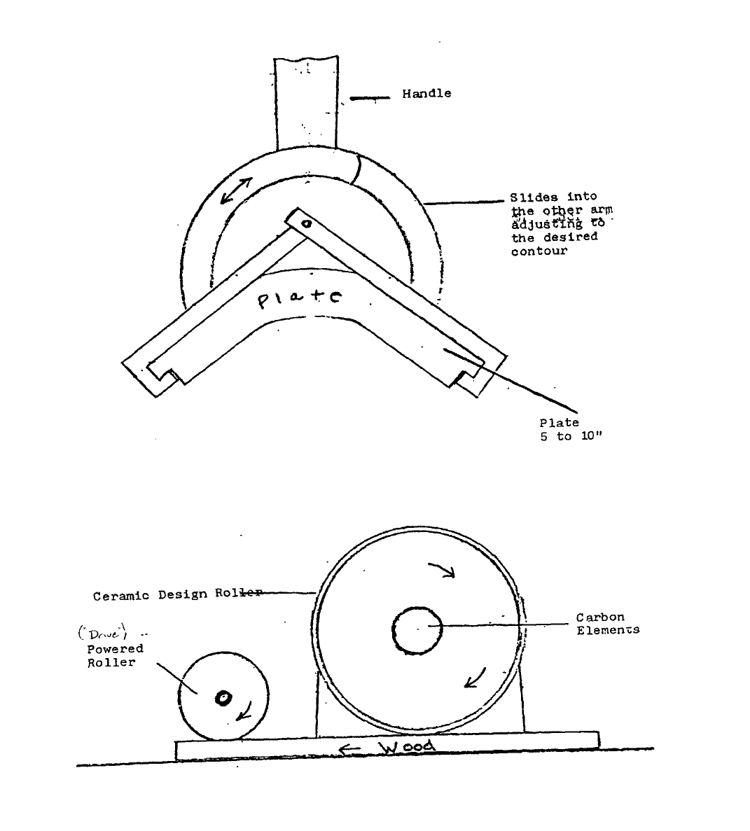

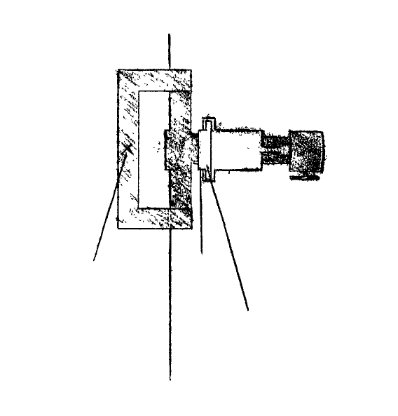

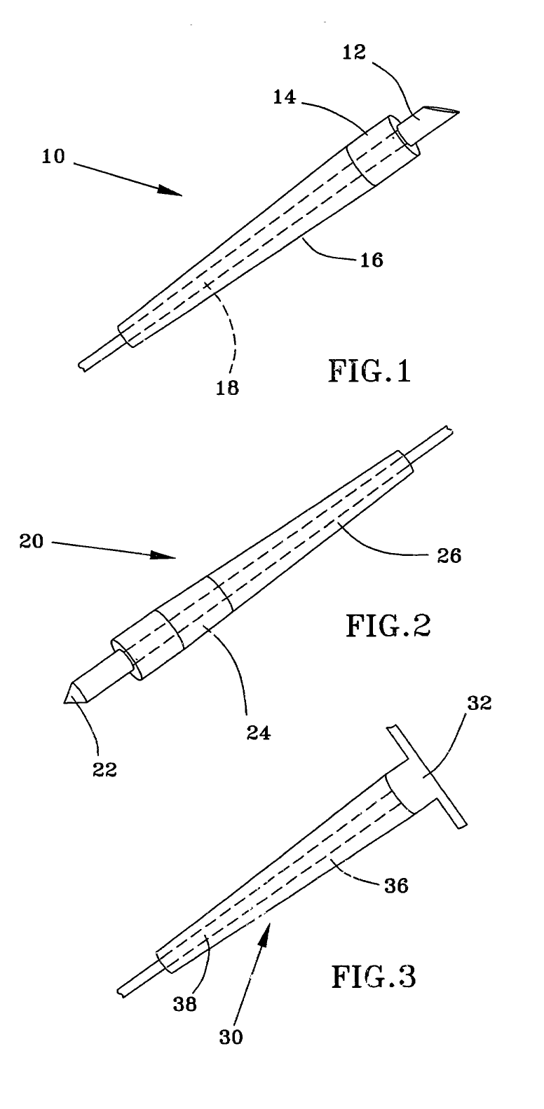

Ceramic wood-burning tools in accordance with this invention are represented in FIGS. 1 through 9, with each being capable of transferring a pattern on the tool to the surface of wood or other material by burning (i.e., char or singe) the near-surface region of the material. The invention is particularly directed toward creating decorative burn patterns in the surface of wood, though various other materials could be treated with the tools of this invention to obtain desirable results. Therefore, though discussed in particular reference to wood, the invention is to be understood to apply to any material in which a pattern can be transferred to its surface by intense localized heating.

Each of the tools shown in FIGS. 1 through 9 comprises a connector or holder supporting a ceramic body on whose exterior surface a raised pattern has been defined. The ceramic body is formed of any suitable ceramic material, such as porcelain and structural clays, the latter of which includes terra cotta and a material commercially available from Eberhard Faber under the name EFAPLAST, composed of clay, binder and hardening materials. Embedded in the ceramic body in close proximity to the raised pattern is a thermal member capable of sufficiently raising the temperature of the raised pattern so that contacting a wood surface with the ceramic body causes the decorative pattern defined by the raised pattern to be transferred to the wood surface. One such thermal member is an electrically-resistive wire, which includes but is not limited to nickel-chromium and nickel-chromium-iron alloys known in the art, a commercial example of which is known as Nichrome. Another such thermal member is an electrically-conductive ceramic material, such as a ceramic material in which metal particles are dispersed. Electrically-conductive ceramic materials that are commercially available include those referred to as thermal ceramics.

In each case, the thermal member is preferably placed in the ceramic body after the body has been shaped but prior to firing, i.e., while the ceramic body is still in a green state. In addition, the raised pattern can be created in the ceramic body (such as by molding, sculpting, rolling, shaving, etc.) prior to or after embedding the thermal member. Firing the ceramic body serves to harden the ceramic material in which the thermal member is embedded, without damaging the thermal member. Electrical connection to the thermal member is provided, either by exposing opposite ends of the electrically-resistive wire, or otherwise contacting the ceramic body so that electric current will pass through the electrically-conductive ceramic material. Any suitable current source may be used.

Transferring the decorative pattern defined by the raised pattern of the ceramic body to the desired wood surface will depend in part on the form of the ceramic body. The ceramic body can have various forms, some of which are represented in FIGS. 1 through 9. In each case, the thermal member preferably raises the temperature of the ceramic body locally at the raised pattern, as opposed to the bulk of the ceramic body. After contacting the wood surface in which the decorative pattern is desired, pressure is applied with the ceramic body to transfer of the pattern to the wood surface occurs over a period of time that will depend in part on the temperature of the raised pattern.

In FIG. 1, a tip tool 10 is shown in which the ceramic body comprises a tip 12 (which defines the “raised pattern” discussed above). The tip 12 is mounted in a holder 14 that preferably can withstand the firing temperatures required for the ceramic material used to form the tip 12. For example, the ceramic material and thermal member (electrically-resistive wire or electrically-conductive ceramic) can be packed into the holder 14 and the ceramic material shaped to define the tip 12, after which the tip 12 is fired. In this manner, the tip 12 and holder 14 can be viewed as together forming the ceramic body discussed above. Alternatively, the thermal member can define the entire tip 12 if an electrically-conductive ceramic is used, in which case the tip 12 and holder 14 may be formed and fired separately, and then assembled such as by screwing the tip 12 into the holder 14. The holder 14 is mounted to a connector 16, through which a cable 18 passes for delivering the required electric current to the thermal member. FIG. 2 is similar to FIG. 1, and shows a carver 20 equipped with a ceramic bit (raised pattern) 22 that can be rotated with a motor 24 housed within the connector 26. The carver 20 is useful for creating fill-in work, such as trees, grass, etc., in a decorative pattern.

FIG. 3 shows a design end 30 having a flat surface 32 in which the raised pattern (not shown) is defined. Similar to the embodiments of FIGS. 1 and 2, the design end 30 is mounted to a connector 36 through which a cable 38 passes for delivering electric current to the thermal member (electrically-resistive wire or electrically-conductive ceramic), which may be embedded in the design end 30 near the surface 32, or define the entire surface 32 if an electrically-conductive ceramic is used.

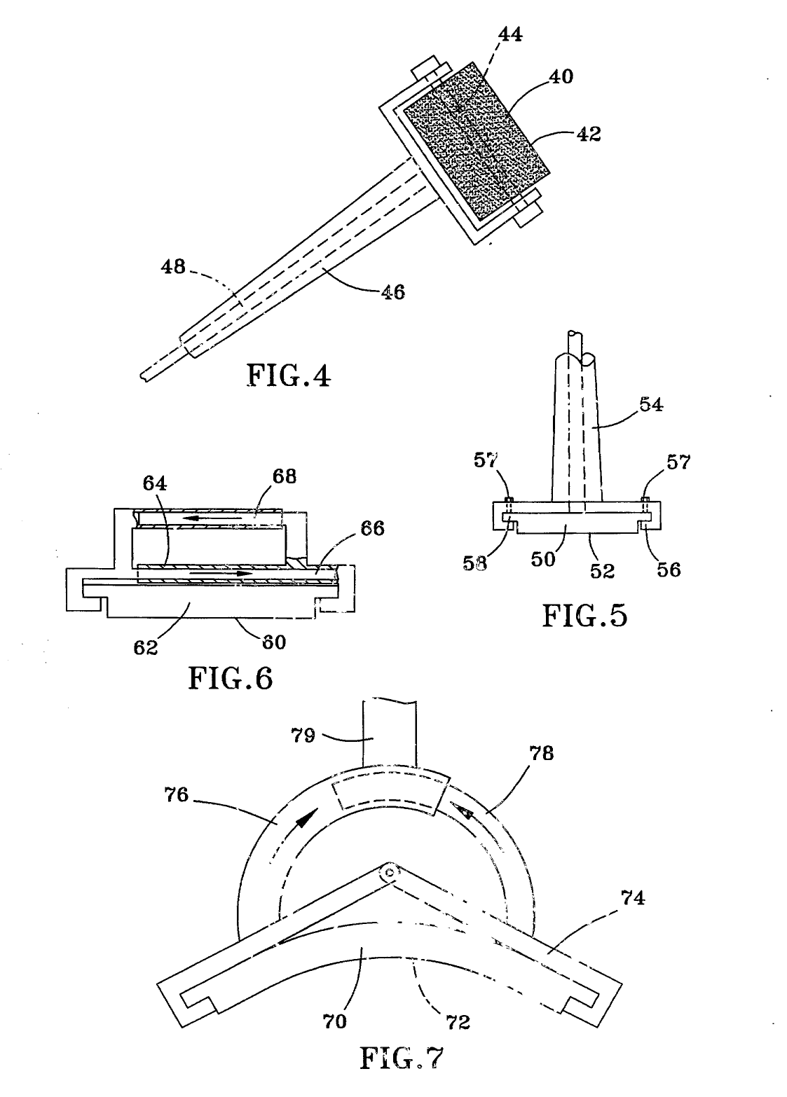

FIG. 4 shows a roller 40 having a cylindrical surface 42 in which a raised pattern (not shown) is defined. A suitable material for the roller 40 is a kiln brick. The roller 40 is shown as being mounted to a connector 46 with an axle 44. Electrical connection to the thermal member (electrically-resistive wire or electrically-conductive ceramic) embedded in the roller 40 is through a conductive path that includes a cable 48 within the connector 46 and a dynamic connection (not shown), such as carbon contacts, which enable current to be delivered to the roller 40 while the roller 40 is rotating. The roller 40 is particularly suitable for creating continuous or repetitive designs desired on long surfaces, such as panels, trim, drawer fronts, doors, etc.

FIG. 5 shows a design plate 50 having a flat surface 52 that, similar to the tool of FIG. 3, has a raised pattern (not shown) defined thereon. The plate 50 differs in its purpose for larger designs, and makes use of a holder 54 with a lip 56 for supporting and gripping a recessed edge 58 of the plate 50, such as with screws 57. Electrical connection to the thermal member (electrically-resistive wire or electrically-conductive ceramic) embedded in the plate 50 is through complementary connections on the holder 54 and plate 50. FIG. 6 shows a design plate 60 that makes use of a holder 64 that supports and grips the plate 60 in the same or similar manner as shown in FIG. 5. However, the holder 64 has telescoping portions 66 and a telescoping handle assembly 68 to enable the holder 64 to adjust in size to plates of different lengths or widths.

FIG. 7 shows a contoured plate 70 that differs from the design plate 70 of FIG. 5 by having a curved surface 72 in which a raised pattern (not shown) is defined for creating a decorative pattern on a curved surface or corner. The plate 70 makes use of a holder 74 that supports and grips the plate 70 in the same or similar manner as shown in FIG. 5. However, the holder 74 is hinged to adjust for plates of different contours. The holder 74 has a support assembly 76 with telescoping curved arms 78 for adjustment of the holder 74, with one of the arms 78 shown being mounted to a handle 79. As before, electrical connection to the thermal member (electrically-resistive wire or electrically-conductive ceramic) embedded in the plate 70 is through complementary connections on the holder 74 and plate 70.

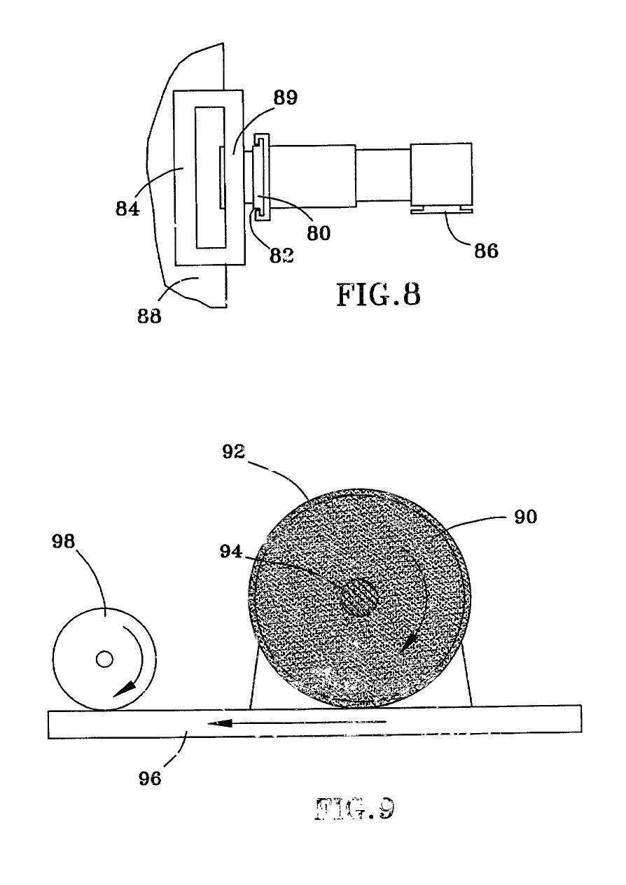

FIG. 8 shows a wood-burning tool adapted for a related but different use than those of the preceding embodiments, namely, burning a mortise 89 into a door or door jamb 88 for receiving a door hinge. For this purpose, the tool makes use of a ceramic body in the form of a plate 80, and is equipped with an adjustable clamp 84 for gripping opposite surfaces of the door/jamb 88, as well as a press 86 mounted to the clamp 84 for applying pressure through the plate 80 to the area of the door or jamb where the mortise is desired. The plate 80 is sized and shaped to duplicate that of the hinge to be mounted. The thermal member (electrically-resistive wire or electrically-conductive ceramic) is embedded in the plate 80, and preferably is uniformly present over the entire surface 82 of the plate 80, such that the surface 82 is effectively the raised pattern that will define the mortise 89. Because of the increased amount of smoke and ash that will be generated, this device may be used in combination with a fan or air filtering system.

Finally, FIG. 9 represents an automated method of continuously transferring a decorative pattern to a surface. A piece of wood 96 is shown passing beneath a roller 90 mounted on an axle 94. The roller 90 has a cylindrical surface 92 in which a raised pattern (not shown) is defined. As with the roller of FIG. 4, the thermal member (electrically-resistive wire or electrically-conductive ceramic) is embedded in the roller 90 near its cylindrical surface 92. Depending on the size of the roller 90, the thermal member may be limited to a layer deposited or otherwise formed on the surface of the roller 90. Electrical connection to the thermal member is through a conductive path that includes a dynamic connection (not shown), such as carbon contacts, which enables current to be delivered from the axle 94 to the roller 90 while the roller 90 is rotating. Finally, a drive roller 98 is shown as causing the wood 96 to move beneath the roller 90 at a speed synchronized with the roller speed. In this manner, the roller 90 can be used to accurately form continuous or repetitive designs on long surfaces, such as boards, doors, drawer fronts, trim, valances, shelves, counter top edges, etc.

With each of the above embodiments, one can make designs, inlays or tips to accurately reproduce a decorative pattern, including continuous and repetitive patterns, on a wide variety of structures. The tools are all practical for use by individuals and small and home-based businesses in view of their relatively low cost and transportability.

While the invention has been described in terms of a preferred embodiment, it is apparent that other forms could be adopted by one skilled in the art. Therefore, the scope of the invention is to be limited only by the following claims.

1. a ceramic wood-burning device comprising a ceramic body having a raised pattern defined on a surface thereof and means for locally heating the raised pattern to a temperature higher than portions of the ceramic body away from the raised pattern, the temperature being sufficient to burn a pattern in a surface of wood contacted by the ceramic body.

2. A ceramic wood-burning device according to claim 1, wherein the heating means comprises an electric current source and an electrically-resistive wire connected thereto, the wire being embedded in the ceramic body in proximity to the raised pattern and locally heating the raised pattern when current from the current source flows therethrough.

3. A ceramic wood-burning device according to claim 2, wherein the electrically-resistive wire is a nickel-chromium or nickel-chromium-iron alloy.

4. A ceramic wood-burning device according to claim 1, wherein the heating means comprises an electric current source and a ceramic material connected thereto, the ceramic material being embedded in the ceramic body in proximity to the raised pattern and being sufficiently electrically conductive to locally heat the raised pattern when current from the current source flows therethrough.

5. A ceramic wood-burning device according to claim 4, wherein the ceramic material comprises a metal powder dispersed in a ceramic matrix.

6. A ceramic wood-burning device according to claim 1, wherein the ceramic body is in the form of a plate.

7. A ceramic wood-burning device according to claim 6, further comprising a clamp for clamping the ceramic body to a door or doorjamb.

8. A ceramic wood-burning device according to claim 6, further comprising a connector to which the plate is mounted and an electrical conductor through the connector for connecting the heating means to an electric current source.

9. A ceramic wood-burning device according to claim 6, wherein the connector is adjustable in size to accommodate the plate.

10. A ceramic wood-burning device according to claim 6, wherein the plate has an arcuate shape.

11. A ceramic wood-burning device according to claim 1, wherein the ceramic body is in the form of a roller.

12. A ceramic wood-burning device according to claim 11, further comprising a connector to which the roller is mounted and an electrical conductor through the connector for connecting the heating means to an electric current source.

13. A ceramic wood-burning device according to claim 1, wherein the ceramic body is in the form of a hand tool and the raised pattern is a pointed tip of the hand tool.

14. A ceramic wood-burning device according to claim 13, further comprising a connector to which the roller is mounted and an electrical conductor through the connector for connecting the heating means to an electric current source.

15. A method of burning a pattern in a surface of wood, the method comprising the steps of:
providing a ceramic body having a raised pattern defined on a surface thereof;
passing electrical current through the ceramic body to heat the raised pattern to a temperature sufficient to burn wood, the temperature of the raised pattern being higher than portions of the ceramic body away from the raised pattern; and then
contacting the surface of the wood with the ceramic body to burn the pattern in the surface of the wood.

16. A method according to claim 1, wherein the electric current passes through an electrically-resistive wire embedded within the ceramic body in proximity to the raised pattern.

17. A method according to claim 16, wherein the electrically-resistive wire is a nickel-chromium or nickel-chromium-iron alloy.

18. A method according to claim 1, wherein the electric current passes through a ceramic material embedded within the ceramic body in proximity to the raised pattern, the ceramic material being sufficiently electrically conductive to locally heat the raised pattern when the electric current passes therethrough.

19. A method according to claim 18, wherein the ceramic material comprises a metal powder dispersed in a ceramic matrix.
